(19) United States
(12) Patent Application Publication
(10) Pub. No.: US 2026/0162523 A1
(43) Pub. Date: Jun. 11, 2026

(54) DISTRIBUTED DRIVING SYSTEM WITH INTELLIGENT ROADSIDE TOOLBOX FOR LONG-TAIL SCENARIOS

(71) Applicant: CAVH LLC, Fitchburg, WI (US)

(72) Inventors: Bin Ran, Fitchburg, WI (US); Shen Li, Madison, WI (US); Yang Cheng, Middleton, WI (US); Tianyi Chen, Madison, WI (US); Xiaotian Li, Madison, WI (US); Shuoxuan Dong, Madison, WI (US); Kunsong Shi, Madison, WI (US); Haotian Shi, Madison, WI (US); Yifan Yao, Madison, WI (US); Ran Yi, Madison, WI (US); Keshu Wu, Madison, WI (US); Yang Zhou, Madison, WI (US)

(21) Appl. No.: 19/459,812

(22) Filed: Jan. 26, 2026

Related U.S. Application Data
(63) Continuation of application No. 17/192,529, filed on Mar. 4, 2021.
(60) Provisional application No. 63/004,551, filed on Apr. 3, 2020.

(51) Int. Cl. G05D 1/00

(52) U.S. Cl. CPC G08G 1/0116; G08G 1/0133; G08G 1/0145; G08G 1/096725; G08G 1/096741; G08G 1/096775; G08G 1/096783; G08G 1/096811; G08G 1/167

(57) ABSTRACT

Provided herein is technology relating to a distributed driving system with the support of an intelligent roadside toolbox (IRT) to address long-tail cases. The IRT comprises a cloud and provides fused data from multiple sensors and data sources. A connected automated vehicle (CAV) uses the fused data to supplement its sensing data and maintain its automation level when its components have failure. Moreover, the IRT predicts the movement and behavior of surrounding objects, pedestrians, and bicycles; and provides such vulnerable road user information to the CAV to help the CAV maintain its safe driving and desired autonomous driving level in complex urban environments. For emergency situations or function failure, the IRT provides emergency services and failure safety measures for the CAV.

This application is a continuation of U.S. patent application Ser. No. 17/192,529, filed Mar. 4, 2021, which claims the benefit of U.S. Provisional Ser. No. 63/004,551 , filed Apr. 3, 2020, each of which is incorporated herein by reference in its entirety.

### FIELD

Provided herein is technology relating to transportation operations and management services and particularly, but not exclusively, to systems and methods for an intelligent roadside toolbox (IRT) system that facilitates vehicle operations and control for distributed driving systems (DDS).

### BACKGROUND

Automated driving technologies that control vehicles without human input or with reduced human input are in development. However, existing technologies involve expensive and/or complicated on board systems provided on individual vehicles and/or require substantial time and labor to build roadside infrastructure. For these reasons, widespread implementation of these systems faces substantial challenges.

Some solutions (e.g., as described in U.S. Pat. No. 7,421,334) provide a vehicle on-board system comprising a sensor assembly to collect data and a processor to process the data to determine the occurrence of at least one event. For example, U.S. Pat. No. 7,554,435 describes a vehicle on-board unit configured to communicate with other vehicles to alert a driver of a potential braking event in a preceding vehicle. Other solutions (e.g., as described in U.S. Pat. No. 10,380,886) provide an intelligent roadside infrastructure system to control a vehicle. A limitation of existing technologies is that they consider individual vehicles and roadside infrastructures working separately to realize automated driving. Furthermore, conventional technologies are designed to provide an autonomous driving vehicle system or a connected automated vehicle highway system and do not provide a technology for a distributed driving system.

### SUMMARY

The technology described herein relates to a system for providing vehicle operations and control to connected and automated vehicle and highway (CAVH) systems by sending detailed and time-sensitive control instructions to individual vehicles. In some embodiments, the technology improves, interacts with, and/or comprises aspects (e.g., components) of a system oriented and fully controlled automated vehicle highway (CAVH) system configured to provide various levels of connected and automated vehicles and highways, e.g., as described in U.S. Pat. App. Pub. No. 20180336780, incorporated herein by reference. In some embodiments, the technology improves, interacts with, and/or comprises aspects (e.g., components) of an Intelligent Road Infrastructure System (IRIS), which facilitates vehicle operations and control for CAVH systems, e.g., as described in U.S. Pat. App. Pub. No. 20190244521 and/or U.S. Pat. App. Pub. No. 20190096238, each of which is incorporated herein by reference.

The technology provided herein relates to an Intelligent Roadside Toolbox (IRT) system. In some embodiments, the IRT system is configured to provide a virtual automated driving service to vehicles. In some embodiments, the IRT system is configured to share information and/or driving instructions between vehicles and other automated driving information entities. In some embodiments, the IRT system is configured to share information and/or driving instructions between roadside communication infrastructures and vehicle on-board communication devices. In some embodiments, the IRT system is configured to provide status management services for vehicles.

In some embodiments, the IRT system is configured to enhance, complete, and/or replace the automated driving tasks for individual vehicles. In some embodiments, the automated driving tasks comprises vehicle control. In some embodiments, vehicle control comprises car following, lane changing, route guidance, parking, and maintenance and service. In some embodiments, maintenance and service comprises vehicle fueling or vehicle charging.

In some embodiments, the IRT system is configured to provide sensing functions to vehicles, transportation behavior prediction and management functions to vehicles, planning and decision making functions to vehicles, and/or vehicle control functions to vehicles. In some embodiments, the IRT system is configured to provide sensing services to vehicles, transportation behavior prediction and management services to vehicles, planning and decision making services to vehicles, and/or vehicle control services to vehicles.

In some embodiments, the IRT system is configured and managed as an open platform comprising subsystems owned and/or operated by different entities. In some embodiments, the IRT system is configured and managed as an open platform comprising physical and/or logical subsystems that are shared by different entities. In some embodiments, the IRT system is configured and managed as an open platform comprising a roadside unit (RSU) network; three way interface among the IRT system, vehicles, and supporting systems; traffic control unit (TCU) and traffic control center (TCC) network; and/or traffic operations centers (TOC). In some embodiments, the RSU network is configured to provide sensing functions, communications functions, vehicle control functions, and computation functions. In some embodiments, the computation functions are configured to compute a drivable range of a vehicle. In some embodiments, the supporting systems comprise a cloud-based information platform, high-definition maps, and/or computing services.

In some embodiments, the IRT system is supported by a map service, satellite positioning service, data storage service, cloud service, real-time wired communication, real-time wireless communication, power supply network, and/or a cyber safety and security system.

In some embodiments, the IRT system is configured to provide information at microscopic, mesoscopic, and/or macroscopic levels. In some embodiments, the IRT system is configured to provide driving instructions, supporting information, and/or traffic information. In some embodiments, the automated driving information entities share information with road infrastructure, the cloud, connected and automated vehicles (CAV), and/or emergency services.

In some embodiments, the IRT system is configured to provide automated driving services to individual vehicles operating at a first automated driving level, wherein the services supplement and/or improve the automated driving of the vehicles to allow the vehicles to operate at a second automated driving level, wherein the second automated driving level is higher than the first automated driving level. In some embodiments, the individual vehicles cannot complete automated driving tasks at the first automated driving level. In some embodiments, the individual vehicles can complete the automated driving tasks at the second automated driving level. In some embodiments, the individual vehicles cannot sufficiently and/or effectively complete automated driving tasks at the first automated driving level. In some embodiments, the individual vehicles can sufficiently and/or effectively complete the automated driving tasks at the second automated driving level. In some embodiments, the first automated driving level is less than a target automated driving level. In some embodiments, the second automated driving level is equal to or more than a target automated driving level.

In some embodiments, the IRT system provides a virtual automated driving service that replaces the automated driving functions and/or ability of a vehicle. In some embodiments, the automated driving functions and/or ability of a vehicle are not sufficient to perform necessary, appropriate, and/or required driving tasks of the vehicle. In some embodiments, the IRT system is configured to supplement or replace sensing services provided by a vehicle with virtual sensing services provided by the IRT system. In some embodiments, the IRT system is configured to supplement and/or replace transportation behavior prediction and management services provided by a vehicle with virtual transportation behavior prediction and management services provided by the IRT system. In some embodiments, the IRT system is configured to supplement and/or replace planning and decision making services provided by a vehicle with planning and decision making services provided by the IRT system. In some embodiments, the IRT system is configured to supplement and/or replace vehicle control services provided by a vehicle with vehicle control services provided by the IRT system. In some embodiments, the IRT system is configured to produce sensing data, integrate sensing data, and/or manage sensing data sharing between the IRT system and vehicles to improve vehicle function based on a target system intelligence level.

In some embodiments, the IRT system is configured to predict vehicle movements and traffic for a transportation network at a microscopic level, at a mesoscopic level, and/or at a macroscopic level. In some embodiments, the IRT system is configured to predict movement of individual vehicles. In some embodiments, the IRT system is configured to predict longitudinal movements and/or lateral movements of individual vehicles. In some embodiments, the IRT system is configured to predict car following, acceleration, deceleration, stopping, and starting of individual vehicles. In some embodiments, the IRT system is configured to predict lane keeping and/or lane changing of individual vehicles. In some embodiments, the IRT system is configured to predict vehicle movements and/or traffic on a road section. In some embodiments, the IRT system is configured to predict vehicle movements and/or traffic due to special events, traffic incident, weather, weaving section, platoon splitting, platoon formation, platoon integrating, variable speed limit reaction, segment travel time prediction, and/or road segment traffic flow. In some embodiments, the IRT system is configured to predict special events, traffic incident, weather, weaving section, platoon splitting, platoon formation, platoon integrating, variable speed limit reaction, segment travel time, and/or road segment traffic flow. In some embodiments, the IRT system is configured to predict vehicle movements and/or traffic for a road network. In some embodiments, the IRT system is configured to predict road network traffic flow, road network traffic demand, and/or road network travel time.

In some embodiments, the IRT system is configured to generate and/or send route planning and decision making information and/or commands to an onboard unit (OBU) and/or a vehicle control unit (VCU) of an individual vehicle. In some embodiments, the route planning and decision making information and/or commands are specific for an individual vehicle. In some embodiments, the route planning and decision making information and/or commands provide route planning and decision making at a macroscopic level, mesoscopic level, and/or microscopic level. In some embodiments, the route planning and decision making information and/or commands comprise providing route planning. In some embodiments, the route planning comprises generating and/or adjusting a globally optimized route using predicted vehicle movements and traffic. In some embodiments, the predicted vehicle movements and traffic are provided by the IRT system further configured to predict vehicle movements and traffic for a transportation network. In some embodiments, the route planning is used as a reference for planning driving behavior. In some embodiments, the IRT system is configured to provide a driving behavior plan for a transportation network using the globally optimized route and predicted vehicle movements and traffic for a transportation network. In some embodiments, the IRT system is further configured to plan vehicle movement using the driving behavior plan. In some embodiments, the vehicle movement comprises specific and instantaneous control instructions for individual vehicles. In some embodiments, the specific and instantaneous control instructions for individual vehicles are transmitted to a vehicle control unit of an individual vehicle. In some embodiments, the specific and instantaneous control instructions for individual vehicles are individually transmitted to each vehicle control unit of a plurality of vehicle control units of individual vehicles.

In some embodiments, the IRT system is configured to manage the IRT system services and vehicles to coordinate, complete, and/or enhance the vehicle automated driving tasks based on a target system intelligence level.

In some embodiments, the IRT system further comprises a power supply component or subsystem.

In some embodiments, the IRT system further comprises a fee collection component or subsystem. In some embodiments, the fee collection component or subsystem is configured to collect payments from users of the IRT system. In some embodiments, the fee collection component or subsystem is configured to manage user access to services provided by the IRT system based on a subscription and/or fee for service payment system. In some embodiments, the fee collection component or subsystem comprises a database comprising user payment information, user vehicle automated driving level, a target vehicle automated driving level, user vehicle identification information, and/or user vehicle communication information.

In some embodiments, the IRT system is configured to provide vehicle status management services to maintain and/or change a vehicle status. In some embodiments, the vehicle status comprises vehicle location, velocity, and/or acceleration; vehicle route; and/or vehicle longitudinal and/or lateral status. In some embodiments, the vehicle status comprises vehicle ventilation and/or climate control status.

In some embodiments, the IRT system is configured to optimize a plurality of optimization goals comprising one or more of driver comfort, energy consumption, travel time, user route preferences, computing resources, safety, and/or vehicle performance. In some embodiments, driver comfort comprises climate control, ventilation, and/or driver seat adjustment preferences. In some embodiments, safety comprises minimizing and/or eliminating conflicts with other vehicles, avoiding dangerous weather, and/or avoiding obstacles in a road.

In some embodiments, the IRT system is configured to minimize travel time and/or minimize energy consumption. In some embodiments, user route preferences include specifying route type, specifying waypoints, and/or specifying intermediate stops. In some embodiments, route type comprises major highway and/or scenic route. In some embodiments, waypoints comprise points of interest. In some embodiments, the IRT system is configured to allocate and/or distribute power to one or more components of the IRT system and/or CAVH system to optimize the optimization goals.

In some embodiments, the IRT system is configured to provide customized software configurations based on user preferences and/or service provider requests to improve the automated driving level, safety, and/or stability of individual vehicles. In some embodiments, the IRT system comprises customized hardware structure and/or configuration based on user preferences and/or service provider requests to improve the automated driving level, safety, and/or stability of individual vehicles. In some embodiments, the IRT system is configurable to comprise customized hardware structure and/or configuration based on user preferences and/or service provider requests to improve the automated driving level, safety, and/or stability of individual vehicles.

In some embodiments, the IRT system is configured to manage and control power, computing, communications, and/or intelligence resources and/or services provided by the IRT according to an optimization strategy.

In some embodiments, the technology provides an automated driving services community based on an IRT system in which the automated driving services community provides an interface for automated driving applications.

Also provided herein are methods employing any of the systems described herein for the management of one or more aspects of automated driving of a CAV. The methods include those processes undertaken by individual participants in the system (e.g., drivers, public or private local, regional, or national transportation facilitators, government agencies, etc.) as well as collective activities of one or more participants working in coordination or independently from each other. For instance, in some embodiments, the technology provides a method for providing a virtual automated driving service to vehicles. For example, in some embodiments, methods comprise providing an Intelligent Roadside Toolbox (IRT) system as described herein. In some embodiments, the technology provides a method for providing a virtual automated driving service to vehicles. In some embodiments, methods comprise providing an automated driving services community based on an IRT system as described herein and in which the automated driving services community provides an interface for automated driving applications.

Some portions of this description describe the embodiments of the technology in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, or any combinations thereof.

Certain steps, operations, or processes described herein may be performed or implemented with one or more hardware or software modules, alone or in combination with other devices. In some embodiments, a software module is implemented with a computer program product comprising a computer readable medium containing computer program code, which can be executed by a computer processor for performing any or all steps, operations, or processes described.

In some embodiments, systems comprise a computer and/or data storage provided virtually (e.g., as a cloud computing resource). In particular embodiments, the technology comprises use of cloud computing to provide a virtual computer system that comprises the components and/or performs the functions of a computer as described herein. Thus, in some embodiments, cloud computing provides infrastructure, applications, and software as described herein through a network and/or over the internet. In some embodiments, computing resources (e.g., data analysis, calculation, data storage, application programs, file storage, etc.) are remotely provided over a network (e.g., the internet, CAVH communications, cellular network). See, e.g., U.S. Pat. App. Pub. No. 20200005633, incorporated herein by reference.

Embodiments of the technology may also relate to an apparatus for performing the operations herein. This apparatus may be specially constructed for the required purposes and/or it may comprise a general-purpose computing device selectively activated or reconfigured by a computer program stored in the computer. Such a computer program may be stored in a non-transitory, tangible computer readable storage medium or any type of media suitable for storing electronic instructions, which may be coupled to a computer system bus. Furthermore, any computing systems referred to in the specification may include a single processor or may be architectures employing multiple processor designs for increased computing capability.

Additional embodiments will be apparent to persons skilled in the relevant art based on the teachings contained herein.

### BRIEF DESCRIPTION OF THE DRAWINGS

These and other features, aspects, and advantages of the present technology will become better understood with regard to the following drawings.

FIG. 1 is a schematic drawing showing exemplary physical subsystems for embodiments of the IRT technology provided herein. 101: Intelligent roadside toolbox; 102: sensing devices; 103: computation devices; 104: communication devices; 105: supporting subsystems; 106: TCU/TCC; 107: TOC; 108: Vehicle subsystems.

FIG. 2 is a diagram showing embodiments of the technology in which an IRT provides information to support a CAV and provide emergency services. 201: IRT; 202: CAV; 203: Emergency service.

FIG. 3 is a schematic diagram showing embodiments of the technology in which IRT collects information from different driving entities and distributes information to different driving entities. 301: CAV; 302: Emergency service; 303: Cloud; 304: IRT; 305: Infrastructure; 306: communication channel between IRT and Cloud; 307: communication channel between IRT and emergency vehicle; 308: communication channel between IRT and vehicles; 309: communication channel between IRT and infrastructure.

FIG. 4 is a flowchart showing embodiments of the technology in which IRT supports and/or improves automated driving tasks. 401: IRT retrieving a vehicle automated driving level; 402: Checking if the vehicle automated driving level can be improved by IRT; 403: IRT service selection; 404: Automated driving enhancement.

FIG. 5 is a flowchart showing embodiments of the technology in which IRT supports a vehicle to perform automated driving tasks. 501: the user specified (“goal”) automated driving level: 502: checking the automated driving level of a vehicle; 503: comparing the vehicle level and goal level; 504: if match, start automated driving; 505: if not match, select services from IRT; 506: the vehicle completes automated driving task.

FIG. 6 is a flowchart showing embodiments of the technology in which the automated driving system of a vehicle is replaced by services and/or functions provided by the IRT (e.g., the automated driving functions of a vehicle automated driving system are replaced by automated driving functions provided by the IRT). 601: the user-specified (“goal”) automated driving level; 602: checking the automated driving level of a vehicle; 603: replacing driving tasks by IRT Service; 604: Continue automated driving operated by vehicle.

FIG. 7 is a data flow diagram for embodiments of the technology related to IRT sensing functions (e.g., methods and systems), e.g., that are provided for a DDS. 701: Distributed Driving System; 702: Intelligent Roadside Toolbox; 703: Connected Automated Vehicle; 704: Communication module in IRT; 705: Sensing Module in IRT; 706: Communication module in CAV; 707: Sensing Module in CAV; 708: data flow between DDS and IRT communication module; 709: data flow between DDS and CAV communication module; 710: data flow between IRT and CAV; 711 Data flow between IRT sensing module and communication module; 712: Data flow between CAV sensing module and communication module.

FIG. 8 is a data flow diagram for embodiments of the technology related to IRT transportation behavior prediction and management functions (e.g., systems and methods), e.g., as provided by a prediction and management unit of an IRT. 801: processed information from sensing module; 802: Prediction and Management Unit; 803: Macroscopic level prediction for the road network; 804: Mesoscopic level prediction for road corridor and segments; 805: Microscopic level prediction for individual vehicles; 806: Planning unit for planning and decision making.

FIG. 9 is a data flow diagram for embodiments of the technology related to IRT decision making functions (e.g., systems and methods), e.g., using predictions provided by the prediction and management unit. 901: Prediction Unit in IRT; 902: Planning and Decision-Making Unit; 903: Control Unit on CAV; 904: Macroscopic level route planning; 905: Mesoscopic level behavior planning; 906: Microscopic level motion planning.

FIG. 10 is a data flow diagram for embodiments of the technology related to IRT control functions (e.g., systems and methods), e.g., that are provided for a DDS. 1001: Distributed Driving System; 1002: Intelligent Roadside Toolbox; 1003: Connected Automated Vehicle; 1004: Communication module in IRT; 1005: Planning Module in IRT; 1006: Communication module in CAV; 1007: Control Module in CAV; 1008: Control flow between DDS and IRT communication module; 1009: Control flow between DDS and CAV communication module; 1010: Data flow between IRT and CAV; 1011 Control flow between IRT planning module and communication module; 1012: Control flow between CAV control module and communication module.

FIG. 11 is a data flow diagram for embodiments of the technology related to IRT service provision functions.

FIG. 12 is a diagram showing an automated driving community based on the IRT. 1201: User interface; 1202: Automated Driving Community; 1203: Driving Applications.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

Provided herein is technology relating to transportation operations and management services and particularly, but not exclusively, to systems and methods for an intelligent roadside toolbox (IRT) that facilitates vehicle operations and control for distributed driving systems (DDS). In some embodiments, the technology provides systems, designs, and methods for an IRT that facilitates, provides, and/or supports vehicle operations and control for distributed driving systems (DDS). In some embodiments, the IRT system provides vehicles with individually customized information and real-time control instructions for the vehicle to perform driving tasks, e.g., car following, lane changing, and/or route guidance. In some embodiments, the IRT system also provides transportation operations and management services (e.g., for freeways, urban arterials, and other roads and streets). In some embodiments, the IRT comprises one or more of the following components: 1) sensing devices; 2) computation devices; 3) communication devices; 4) TCC/TCU; 5) TOC; and/or 6) supporting devices. In some embodiments, the IRT system provides one or more of the following function categories: sensing, transportation behavior prediction and management, planning and decision making, and/or vehicle control. In some embodiments, the IRT comprises and/or is supported by real-time wired and/or wireless communication, power supply networks, the cloud, cyber safety, security services, and/or human machine interfaces.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, disclosure of ranges includes disclosure of all values and further divided ranges within the entire range, including endpoints and sub ranges given for the ranges.

As used herein, the suffix “-free” refers to an embodiment of the technology that omits the feature of the base root of the word to which “free” is appended. That is, the term “X-free” as used herein means “without X”, where X is a feature of the technology omitted in the “X-free” technology. For example, a “controller-free” system does not comprise a controller, a “sensing-free” method does not comprise a sensing step, etc.

Although the terms “first”, “second”, “third”, etc. may be used herein to describe various steps, elements, compositions, components, regions, layers, and/or sections, these steps, elements, compositions, components, regions, layers, and/or sections should not be limited by these terms, unless otherwise indicated. These terms are used to distinguish one step, element, composition, component, region, layer, and/or section from another step, element, composition, component, region, layer, and/or section. Terms such as “first”, “second”, and other numerical terms when used herein do not imply a sequence or order unless clearly indicated by the context. Thus, a first step, element, composition, component, region, layer, or section discussed herein could be termed a second step, element, composition, component, region, layer, or section without departing from technology.

As used herein, a “system” refers to a plurality of real and/or abstract components operating together for a common purpose. In some embodiments, a “system” is an integrated assemblage of hardware and/or software components. In some embodiments, each component of the system interacts with one or more other components and/or is related to one or more other components. In some embodiments, a system refers to a combination of components and software for controlling and directing methods.

As used herein, the term “Connected Automated Vehicle Highway System” (“CAVH System”) refers to a comprehensive system providing full vehicle operations and control for connected and automated vehicles (CAV), and, more particularly, to a system controlling CAVs by sending individual vehicles with detailed and time-sensitive control instructions for vehicle following, lane changing, route guidance, and related information. A CAVH system comprises sensing, communication, and control components connected through segments and nodes that manage an entire transportation system. CAVH systems comprise four control levels: a) vehicle; b) roadside unit (RSU); c) traffic control unit (TCU); and d) traffic control center (TCC). See U.S. Pat. App. Pub. Nos. 20180336780, 20190244521, and/or 20190096238, each of which is incorporated herein by reference.

As used herein, the term “Intelligent Road Infrastructure System” (“IRIS”) refers to a system that facilitates vehicle operations and control for CAVH systems. See U.S. Pat.

App. Pub. Nos. 20190244521 and/or 20190096238, each of which is incorporated herein by reference.

As used herein, the term “support” when used in reference to one or more components of the ITS, DDS, IRIS, and/or CAVH system providing support to and/or supporting a vehicle (e.g., a CAV) and/or one or more other components of the ITS, DDS, IRIS, and/or CAVH system refers to, e.g., exchange of information and/or data between components and/or levels of the ITS, DDS, IRIS, CAVH system, and/or vehicle; sending and/or receiving instructions between components and/or levels of the ITS, DDS, IRIS, CAVH system, and/or vehicle; and/or other interaction between components and/or levels of the ITS, DDS, IRIS, CAVH system, and/or vehicle that provide functions such as information exchange, data transfer, messaging, and/or alerting.

As used herein, the term “autonomous vehicle” or “AV” refers to an autonomous vehicle, e.g., at any level of automation (e.g., as defined by SAE International Standard J3016 (2014), incorporated herein by reference).

As used herein, the term “connected vehicle” or “CV” refers to a connected vehicle, e.g., configured for any level of communication (e.g., V2V, V2I, and/or I2V).

As used herein, the term “connected and autonomous vehicle” or “CAV” refers to an autonomous vehicle that is able to communicate with other vehicles (e.g., by V2V communication), with roadside units (RSUs), an IRT, traffic control signals, and other infrastructure (e.g., an IRIS, CAVH system) or devices. That is, the term “connected autonomous vehicle” or “CAV” refers to a connected autonomous vehicle having any level of automation (e.g., as defined by SAE International Standard J3016 (2014)) and communication (e.g., V2V, V2I, and/or I2V).

As used herein, the term “data fusion” refers to integrating a plurality of data sources to provide information (e.g., fused data) that is more consistent, accurate, and useful than any individual data source of the plurality of data sources.

In some embodiments, various spatial and temporal scales or levels are used herein, e.g., microscopic, mesoscopic, and macroscopic. As used herein, the “microscopic level” refers to a scale relevant to individual vehicles and movements of individual vehicles (e.g., longitudinal movements (car following, acceleration and deceleration, stopping and standing) and/or lateral movements (lane keeping, lane changing)). As used herein, the “mesoscopic level” refers to a scale relevant to road corridors and segments and movements of groups of vehicles (e.g., special event early notification, incident prediction, weaving section merging and diverging, platoon splitting and integrating, variable speed limit prediction and reaction, segment travel time prediction, and segment traffic flow prediction). As used herein, the term “macroscopic level” refers to a scale relevant for a road network (e.g., route planning, congestion, incidents, network traffic). As used herein, the term “microscopic level”, when referring to a temporal scale, refers to a time of approximately 1 to 10 milliseconds (e.g., relevant to vehicle control instruction computation). As used herein, the term “mesoscopic level”, when referring to a temporal scale, refers to a time of approximately 10 to 1000 milliseconds (e.g., relevant to incident detection and pavement condition notification). As used herein, the term “macroscopic level”, when referring to a temporal scale, refers to a time that is approximately longer than 1 second (e.g., relevant to route computing).

As used herein, the term “automation level” or “automated driving level” refers to a level in a classification system describing the amount of driver intervention and/or attentiveness required for an AV, CV, and/or CAV. In particular, the term “automation level” refers to the levels of SAE International Standard J3016 (2014)) entitled “Taxonomy and Definitions for Terms Related to On-Road Motor Vehicle Automated Driving Systems” and updated in 2016 as J3016_201609, each of which is incorporated herein by reference. The SAE automation levels are briefly described as Level 0: “no automation” (e.g., a fully manual vehicle with all aspects of driving being human and manually controlled); Level 1: “driver assistance” (e.g., a single automated aspect such as steering, speed control, or braking control); Level 2: “partial automation” (e.g., human control with automated control of steering and acceleration/deceleration); Level 3: “conditional automation” (e.g., vehicles make informed decisions and human assumes control when the vehicle cannot execute a task); Level 4: “high automation” (e.g., vehicles make informed decisions and human is not required to assume control when the vehicle cannot execute a task); and Level 5: “full automation” (e.g., vehicles do not require human attention).

As used herein, the term “configured” refers to a component, module, system, sub-system, etc. (e.g., hardware and/or software) that is constructed and/or programmed to carry out the indicated function.

As used herein, the terms “determine,” “calculate,” “compute,” and variations thereof, are used interchangeably to any type of methodology, processes, mathematical operation, or technique.

As used herein, the term “vehicle” refers to any type of powered transportation device, which includes, and is not limited to, an automobile, truck, bus, motorcycle, or boat. The vehicle may normally be controlled by an operator or may be unmanned and remotely or autonomously operated in another fashion, such as using controls other than the steering wheel, gear shift, brake pedal, and accelerator pedal.

### Description

The technology provided herein relates to an intelligent roadside toolbox (IRT) providing transportation management and operations functions and vehicle control for connected and automated vehicles (CAV). In some embodiments, the technology provides a system configured to control and/or support CAVs by providing individual vehicles with customized, detailed, and time-sensitive control instructions and traffic information (e.g., vehicle following, lane changing, route guidance, and other related information) for automated vehicle driving.

### Intelligent Roadside Toolbox (IRT)

In some embodiments, the IRT provides modular (e.g., real-time and ad hoc) access to CAVH and IRIS technologies according to the automated driving needs of a particular vehicle. In some embodiments, modular (e.g., ad hoc) access to CAVH and IRIS technologies are provided as services (e.g., sensing services, transportation behavior prediction and management services, planning and decision making services, and/or vehicle control services).

For example, in some embodiments, the IRT described herein provides a flexible and expandable service for vehicles at different automation levels. In some embodiments, the services provided by the IRT are dynamic and customized for particular vehicles, for vehicles produced by a particular manufacturer, for vehicles associated by a common industry alliance, for vehicles subscribing to a DDS, etc. While CAVH technologies relate to centralized systems configured to provide individual vehicles with customized, detailed, and time-sensitive control instructions and traffic information to all vehicles using the CAVH system for automated vehicle driving regardless of vehicle capability and/or automation level and thus provide a homogeneous service, the IRT technologies described herein are vehicle oriented, modular, and customizable for each vehicle to meet the specific needs of each individual vehicle as an on demand and dynamic service. In some embodiments, a vehicle onboard system is configured to generate control instructions for automated driving of a CAV comprising the vehicle onboard system; and the IRT provides customized, on-demand, and dynamic IRT functions to individual CAVs (e.g., sensing services, transportation behavior prediction and management services, planning and decision-making services, vehicle control services, system security and backup, vehicle performance optimization, computing and management, and dynamic utility management (DUM) and information provision).

In some embodiments, the IRT provides customized, on demand, and dynamic IRT functions to improve safety and stability of individual CAVs according to the needs of individual CAVs by assembling IRT functions and providing IRT functions to individual CAVs. In some embodiments, the IRT is configured to provide a customized service for vehicle manufacturers and/or driving services providers, the customized service comprising remote control service, pavement condition detection, and/or pedestrian prediction. In some embodiments, the IRT is configured to receive information from a vehicle OBU, electronic stability program (ESP), and/or vehicle control unit (VCU).

In some embodiments, the IRT is configured to integrate sensor and/or driving environment information from different resources to provide integrated sensor and/or driving environment information and pass the integrated sensor and/or driving environment information to a prediction module. In some embodiments, the IRT is configured to provide customized, on demand, and dynamic IRT functions to individual CAVs for sensing, transportation behavior prediction and management, planning and decision making, and/or vehicle control. In some embodiments, sensing comprises providing information in real-time, short-term, and/or long-term for transportation behavior prediction and management, planning and decision making, and/or vehicle control. In some embodiments, the IRT is configured to provide customized, on demand, and dynamic IRT sensing functions for automated driving of a CAV using information obtained from the CAV and/or other CAVs and/or information obtained from the IRT. In some embodiments, the IRT is configured to provide customized, on demand, and dynamic IRT transportation behavior prediction and management functions for automated driving of a CAV, wherein the transportation behavior prediction and management functions predict the behavior of surrounding vehicles, pedestrians, bicycles, and other moving objects.

In some embodiments, the transportation behavior prediction and management functions provide prediction support comprising providing raw data and/or providing features extracted from raw data; and/or a prediction result, wherein prediction support and/or a prediction result is/are provided to a CAV based on the prediction requirements of the CAV. In some embodiments, the IRT is configured to provide customized, on demand, and dynamic IRT planning and decision making functions for automated driving of a CAV. In some embodiments, the planning and decision making functions provide path planning comprising identifying and/or providing a detailed driving path at a microscopic level for automated driving of a CAV; route planning comprising identifying and/or providing a route for automated driving of a CAV; special condition planning comprising identifying and/or providing a detailed driving path at a microscopic level and/or a route for automated driving of a CAV during special weather conditions or event conditions; and/or disaster solutions comprising identifying and/or providing a detailed driving path at a microscopic level and/or a route for automated driving of a CAV during a disaster, wherein path planning, route planning, special condition planning, and/or disaster solutions is/are provided to a CAV based on the planning and decision making requirements of the CAV.

In some embodiments, the IRT comprises a control module and a decision making module. In some embodiments, the IRT is configured to provide customized, on demand, and dynamic IRT vehicle control functions for automated driving of a CAV. In some embodiments, the vehicle control functions are supported by customized, on demand, and dynamic IRT sensing functions; customized, on demand, and dynamic IRT transportation behavior prediction and management functions; and/or customized, on-demand, and dynamic IRT planning and decision making functions. In some embodiments, vehicle control functions provide lateral control, vertical control, platoon control, fleet management, and system failure safety measures for a CAV. In some embodiments, system failure safety measures are configured to provide sufficient response time for drivers to assume control of a vehicle during system failure and/or to stop vehicles safely. In some embodiments, the vehicle control functions are configured to determine the computation resources supporting automated driving of a CAV and request and/or provide supplemental computation resources from the IRT. In some embodiments, the control module is configured to integrate and/or process information provided by the decision making module and to send vehicle control commands to CAVs for automated driving of the CAVs.

In some embodiments, the IRT comprises hardware modules. In some embodiments, the hardware modules comprise one or more of, e.g., a sensing module comprising sensors, a communications module, and/or a computation module. In some embodiments, the IRT comprises software modules. In some embodiments, the software modules comprise one or more of e.g., sensing software configured to use information from a sensing module to provide object detection and mapping; and decision making software configured to provide paths, routes, and/or control instructions for CAVs.

In some embodiments, the IRT is configured to collect sensor data describing the environment of a CAV; and provide at least a subset of the sensor data to a CAV to supplement CAV automated driving level. In some embodiments, the sensor data is provided by an IRT sensing module. In some embodiments, the sensor data and the subset of the sensor data are communicated between the IRT and the CAV over a communications medium. In some embodiments, the sensor data comprises information describing road conditions, traffic signs and/or signals, and objects surrounding the CAV. In some embodiments, the IRT is further configured to integrate the data; provide the data to a prediction, planning, and decision making system; store the data; and/or retrieve the at least a subset of data.

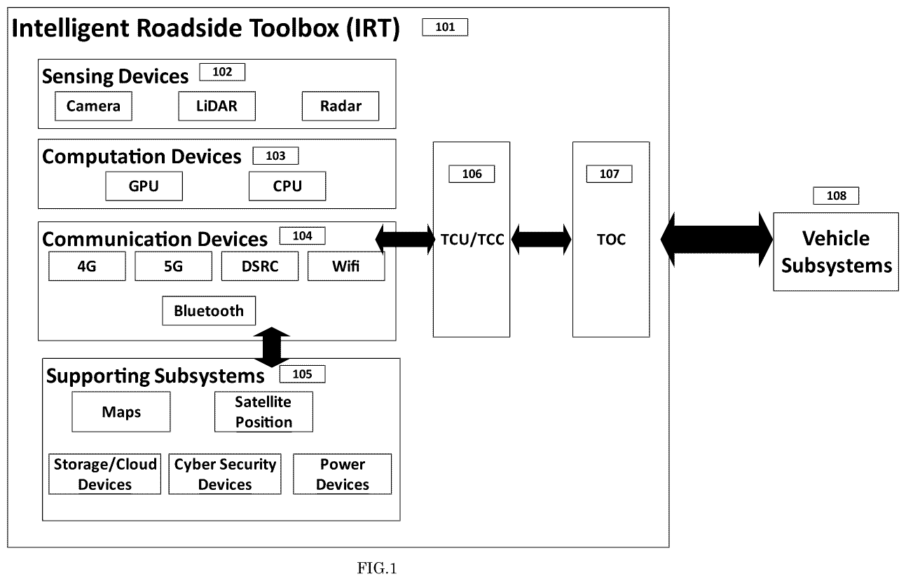

For example, in some embodiments, e.g., as shown in FIG. 1, the technology comprises physical subsystems (e.g., components) for the IRT technology provided herein. In some embodiments, the IRT (101) comprises sensing devices (102), computation devices (103), communication devices (104), and/or supporting subsystems (105). In some embodiments, the sensing devices comprise a camera, lidar, radar, microphone, motion sensor, and/or sound sensor. In some embodiments, the computation devices comprise one or more of a central processing unit, a graphics processing unit, signal processor, or other microprocessor. In some embodiments, the communications devices comprise components for communicating over wired and/or wireless communications (e.g., cellular (e.g., 4G, 5G, or other cellular technology)), Dedicated Short Range Communication (DSRC), WiFi (e.g., IEEE 802.11), and/or Bluetooth). Furthermore, in some embodiments, the IRT (101) shares information with a TCU/TCC (106), TOC (107), and/or vehicle subsystems (108), e.g., using communication devices (104).

In some embodiments, the IRT sends information and/or control instructions for driving tasks (e.g., vehicle control (e.g., car following, lane changing, route guidance, and parking), maintenance, and services (e.g., fueling and charging)) to an individual vehicle. In some embodiments, the IRT comprises and/or provides a component and/or system that is configured to provide one or more functions, e.g., sensing functions, transportation behavior prediction and management functions, planning and decision making functions, and/or vehicle control functions. In some embodiments, an IRT support system comprises one or more subsystems configured to provide support to the IRT. In some embodiments, supporting subsystems comprise one or more of, e.g., high-resolution map data and/or database, satellite position data and/or satellite positioning receiver (e.g., Global Positioning System, BeiDou Navigation Satellite System, Galileo positioning system, GLONASS (Global Navigation Satellite System), etc.), storage devices, cloud services, cybersecurity devices, and/or power supply devices.

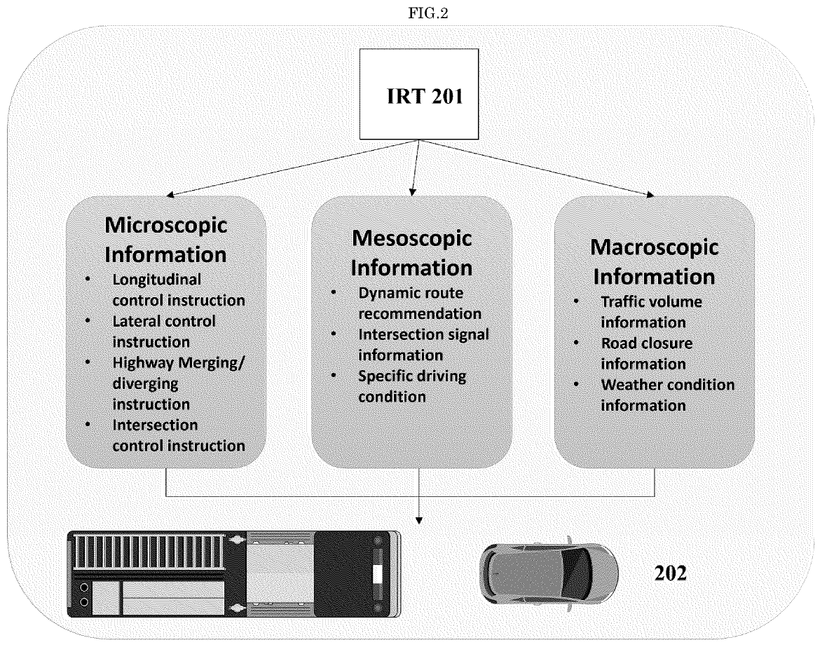

In some embodiments, e.g., as shown in FIG. 2, an IRT (201) provides information to support a CAV (202). In some embodiments, an IRT provides emergency services (203). In some embodiments, the information provided to a CAV is provided in one or more of three content levels: microscopic, mesoscopic, and macroscopic. In some embodiments, microscopic content comprises driving instructions (e.g., longitudinal control instructions, lateral control instructions, merging instructions, diverging instructions, intersection control instructions, velocity instructions, acceleration instructions, turning instructions, and/or braking instructions). In some embodiments, mesoscopic content comprises supporting information (e.g., dynamic route recommendation, intersection traffic control (e.g., traffic signal) information, and/or information describing specific driving conditions). In some embodiments, macroscopic content comprises traffic information (e.g., traffic volume information, road closure information, and/or weather condition information).

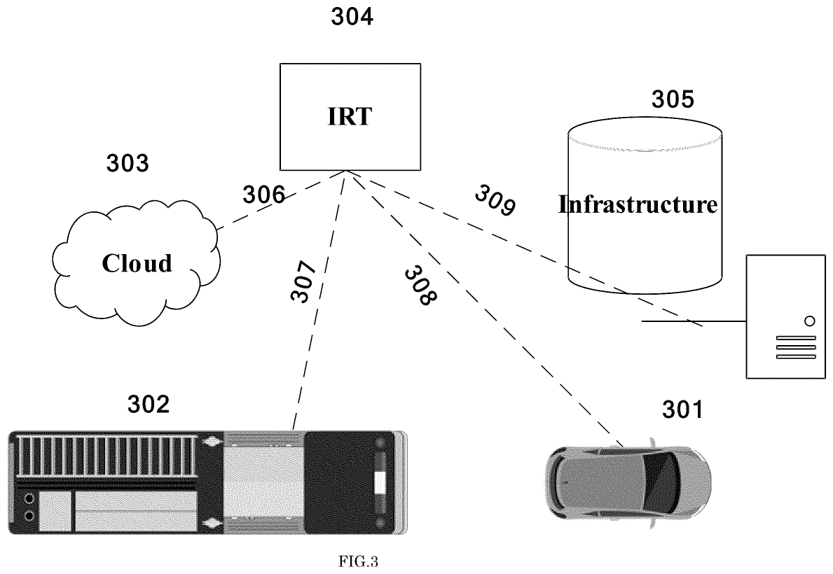

In some embodiments, e.g., as shown in FIG. 3, an IRT collects information from different driving entities and distributes information to different driving entities. For example, in some embodiments, an IRT system shares (e.g., receives and/or transmits) information with, e.g., a CAV (301), an emergency service vehicle (302), the cloud (303), and/or infrastructure (305) (e.g., one or more components of a CAVH system or IRIS (e.g., an RSU, TCC, TCU, and/or TOC)). In some embodiments, the IRT system uses wired and/or wireless communication channels (306, 307, 308, and 309) to distribute information and/or share information with driving entities on the road.

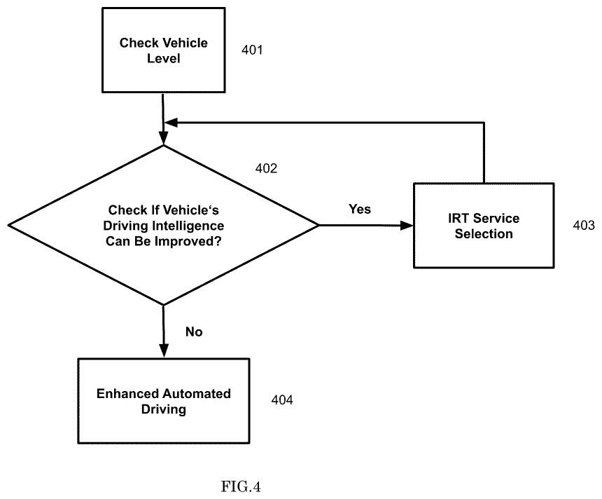

In some embodiments, e.g., as shown in FIG. 4, an IRT supports and/or improves automated driving tasks. For example, in some embodiments, the IRT retrieves information from a vehicle describing the automated driving level of the vehicle (401) and decides if the automated driving level of the vehicle can be improved (402). If the automated driving level of the vehicle can be improved by the IRT, the IRT service selection subsystem (403) provides supplemental services to the vehicle that improve the automated driving level of the vehicle. Then, the IRT checks the automated driving level of the vehicle as improved by the IRT supplemental services. If the automated driving level of the vehicle cannot be improved by the IRT, the vehicle drives at the unimproved automated driving level (404) and the IRT provides supporting services to assist the vehicle at its automation level (e.g., to provide an enhanced automated driving level).

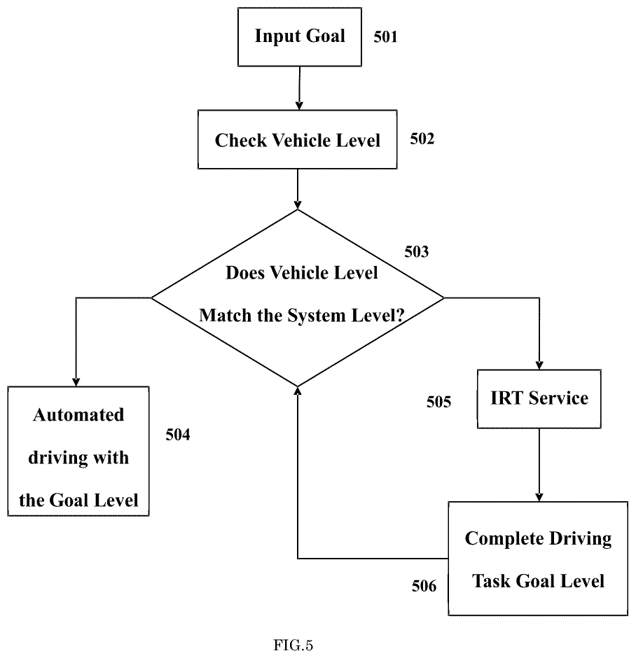

In some embodiments, e.g., as shown in FIG. 5, the IRT provides support to a vehicle to perform automated driving tasks. For example, in some embodiments, IRT supports a vehicle to complete automated driving tasks when the vehicle cannot perform (e.g., cannot effectively and/or sufficiently perform) certain (e.g., necessary and/or appropriate) automated driving tasks or cannot perform at a specified (“goal”) automated driving level. In some embodiments, a user inputs a specified (e.g., “goal”) automated driving level. In some embodiments, a user provides commands for a driving task (e.g., route and/or destination information and/or driving instructions) and/or inputs a specified driving task and the vehicle and/or the IRT determines the specified (“goal”) automated driving level (501) that is appropriate for the driving task input and/or specified by the user. After a user inputs a specified (“goal”) automated driving level (501) and/or a specified (“goal”) automated driving level (501) is determined by the system, the IRT retrieves information from the vehicle describing the automated driving level of the vehicle (502) and compares the automated driving level of the vehicle to the specified (“goal”) automated driving level (503). If the automated driving level of the vehicle matches the specified (“goal”) automated driving level, the vehicle initiates automated driving (504). If the automated driving level of the vehicle does not match the specified (“goal”) automated driving level, the vehicle selects an appropriate service from IRT (505) to supplement vehicle capabilities and/or automated driving capabilities to allow the vehicle to complete the driving task according to the user-specified (“goal”) level (506). Then, the IRT compares the automated driving level of the vehicle as supplemented by the IRT service to the specified (“goal”) automated driving level (503).

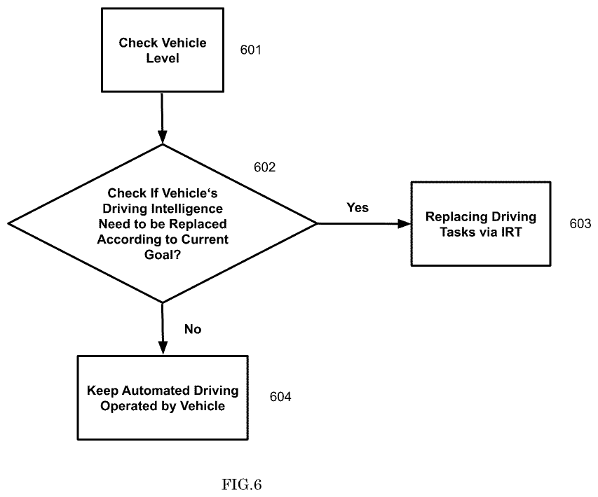

In some embodiments, e.g., as shown in FIG. 6, the automated driving system of a vehicle is replaced by services and/or functions provided by the IRT (e.g., the automated driving functions of a vehicle automated driving system are replaced by automated driving functions provided by the IRT). In some embodiments, a user inputs a specified (e.g., “goal”) automated driving level. In some embodiments, a user provides commands for a driving task (e.g., route and/or destination information and/or driving instructions) and/or inputs a specified driving task and the vehicle and/or the IRT determines the specified (“goal”) automated driving level that is appropriate for the driving task input and/or specified by the user. After a user inputs a specified (“goal”) automated driving level and/or a specified (“goal”) automated driving level is determined by the system, the IRT retrieves information from the vehicle describing the automated driving level of the vehicle (601) and compares the automated driving level of the vehicle to the specified (“goal”) automated driving level (602). If the vehicle automated driving level matches the specified (“goal”) automated driving level, the vehicle continues to drive using the automated driving system and methods provided by the vehicle (604). If the vehicle automated driving level does not match the specified (“goal”) automated driving level, the IRT provides automated driving services to the vehicle (e.g., the IRT assumes control of driving tasks for the automated vehicle), thus replacing the vehicle automated driving system by IRT services and/or functions to provide performance and/or control of the vehicle automated driving tasks by the IRT (603).

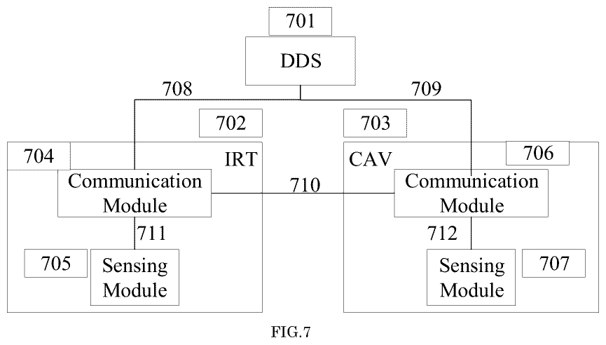

In some embodiments, e.g., as shown in FIG. 7, the IRT (702) provides services comprising sensing functions (e.g., methods and systems), e.g., for a DDS (701). In some embodiments, the IRT comprises a sensing module (e.g., subsystem, unit, and/or component) that is configured to provide sensing functions (e.g., methods and systems), e.g., for a DDS (701). In some embodiments, the DDS sends sensing configuration information and/or instructions (708, 709) to the IRT (702) and CAV (703). The IRT and CAV communication modules (704, 706) receive and transfer (711, 712) the configuration information and/or instructions to the IRT and CAV sensing modules (705, 707). The IRT sensing module (705) and CAV sensing module (707) implement and/or follow the sensing configuration information and/or or instructions received from the DDS (701) and cooperate to provide the appropriate and/or user specified automated driving level (e.g., intelligence) level to the CAV. In some embodiments, the sensing functions receive and/or collect sensing data from multiple sensors (e.g., on one or more CAVs and/or provided by one or more components of a CAVH and/or IRIS infrastructure (e.g., RSU, TCC, TCU, TOC)). In some embodiments, the sensing functions perform data fusion of sensing data, e.g., sensing data collected from multiple sensors on one or more CAVs and/or provided by one or more components of a CAVH and/or IRIS infrastructure (e.g., RSU, TCC, TCU, TOC).

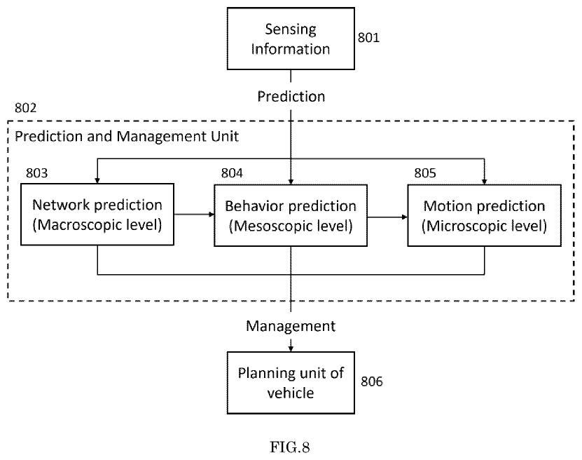

In some embodiments, e.g., as shown in FIG. 8, the IRT provides services comprising transportation behavior prediction and management functions (e.g., systems and methods). In some embodiments, an IRT comprises a transportation prediction and management unit (802) (e.g., system, module, component) that is configured to provide transportation behavior prediction and management functions (e.g., systems and methods). In some embodiments, the sensing module (e.g., as described above and in FIG. 7) sends integrated sensing information (801) to a prediction and management unit (802) of IRT for traffic prediction and management. In some embodiments, transportation behavior prediction and management functions comprise providing data describing transportation and managing traffic on a macroscopic level (e.g., predicting traffic network behavior and/or managing a traffic network (803)). In some embodiments, transportation behavior prediction and management functions comprise providing data describing transportation and managing traffic at a mesoscopic level (e.g., predicting vehicle behavior and/or managing vehicle behavior (804)). In some embodiments, transportation behavior prediction and management functions comprise providing data describing transportation and managing traffic at a microscopic level (e.g., predicting vehicle motion and/or managing vehicle motion (805)). In some embodiments, transportation behavior prediction data and/or information and/or traffic management instructions are sent to the planning unit of vehicles (806) for planning and decision making.

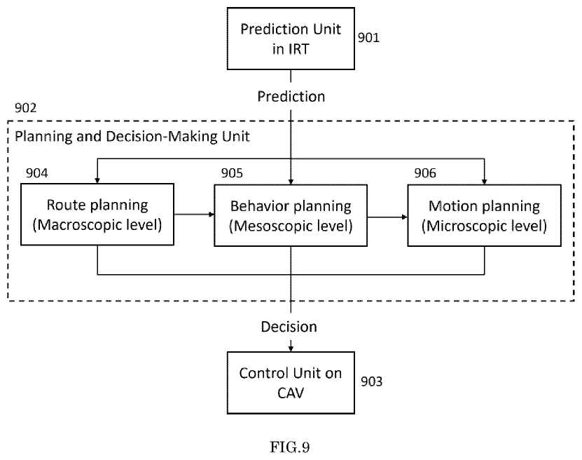

In some embodiments, e.g., as shown in FIG. 9, the IRT provides services comprising planning and decision making functions (e.g., systems and methods), e.g., using predictions provided by the transportation behavior prediction and management unit (901). In some embodiments, the IRT comprises a planning and decision making module (e.g., unit, system, component) that is configured to provide planning and decision making functions (e.g., systems and methods), e.g., using predictions provided by the transportation behavior prediction and management unit (901). In some embodiments, prediction signals (e.g., data describing transportation and/or instructions for managing traffic) are received from the transportation behavior prediction and management unit (901) to the IRT planning and decision making unit (902). In some embodiments, the IRT planning and decision making unit (902) provides planning and decision making on a macroscopic level (e.g., route planning (904)). In some embodiments, the IRT planning and decision making unit (902) provides planning and decision making on a mesoscopic level (e.g., behavior planning (905)). In some embodiments, the IRT planning and decision making unit (902) provides planning and decision making on a microscopic lever (e.g., motion planning (906)). In some embodiments, planning and decisions (e.g., planning and decision data, information, and/or control instructions) generated by the planning and decision making unit (902) are sent to vehicle control units on CAVs (903), e.g., to provide detailed and time-sensitive control instructions to individual vehicles.

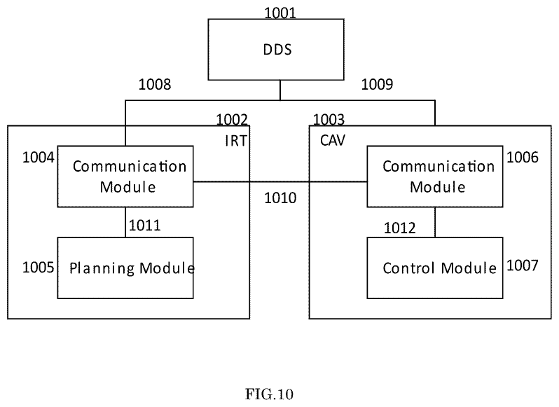

In some embodiments, e.g., as shown in FIG. 10, the IRT (1002) provides services comprising control functions (e.g., systems and methods), e.g., for a DDS (1001). In some embodiments, the IRT comprises a control module (e.g., subsystem, unit, and/or component) that is configured to provide control functions (e.g., systems and methods), e.g., for a DDS (1001). In some embodiments, planning and decisions (e.g., planning and decision data, information, and/or control instructions) generated by the IRT planning and decision-making unit (1005) are provided over a communication channel to a communication module of the IRT. The planning and decisions (e.g., planning and decision data, information, and/or control instructions) generated by the IRT planning and decision making unit (1005) are sent from the communication module (1004) of the IRT (1002) (e.g., over communication channel 1010) to the communication module (1006) of the CAV (1003). CAV (1003) analyzes the planning and decisions (e.g., planning and decision data, information, and/or control instructions), generates commands, and sends commands (e.g., control instructions) (1012) to the control module (1007) of CAV (1003).

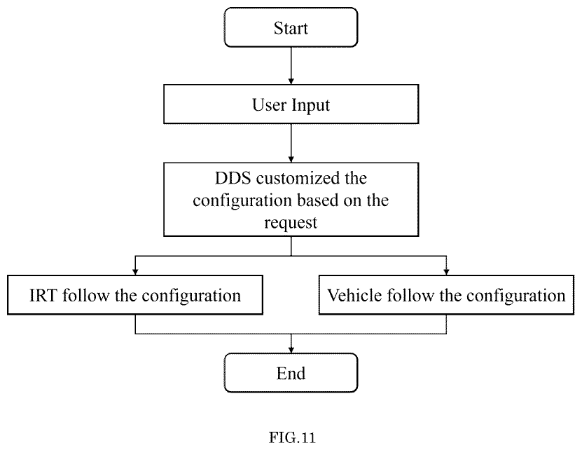

In some embodiments, e.g., as shown in FIG. 11, the IRT provides service provision functions (e.g., systems and methods). In some embodiments, the service provision functions receive a user input, comprising user driving preferences (e.g., route, destination, driving mode, driving behavior, driving comfort, etc.) to the DDS. The DDS then customizes an optimal configuration based on user inputs and sends instructions both to IRT and vehicles. In some embodiments, the IRT provides services to the vehicles to implement the user preferences.

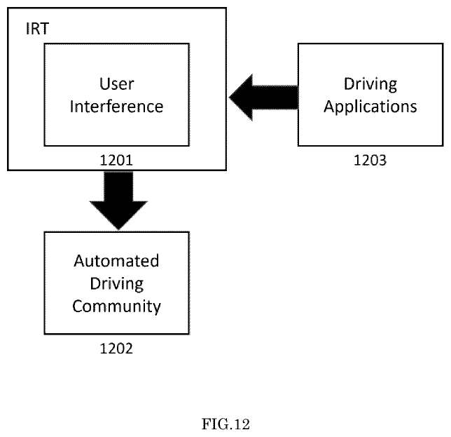

In some embodiments, e.g., as shown in FIG. 12, the technology relates to providing information to an automated driving community and/or managing an automated driving community using the IRT described herein. In some embodiments, the IRT provides a user interface (1201) for a variety of driving applications (1203) to join the automated driving community (1202). The automated driving community shares the applications with other entities in the community.

### Distributed Driving System

In some embodiments, the technology provided herein provides a distributed driving system (DDS) comprising an intelligent roadside toolbox (IRT). In some embodiments, the IRT provides modular (e.g., ad hoc) access to CAVH and IRIS technologies according to the automated driving needs of a particular vehicle. In some embodiments, modular (e.g., ad hoc) access to CAVH and IRIS technologies are provided as services (e.g., sensing services, transportation behavior prediction and management services, planning and decision-making services, and/or vehicle control services).

For example, in some embodiments, the IRT described herein provides a flexible and expandable service for vehicles at different automation levels. In some embodiments, the services provided by the IRT are dynamic and customized for particular vehicles, for vehicles produced by a particular manufacturer, for vehicles associated by a common industry alliance, for vehicles subscribing to a DDS to obtain services from the IRT, etc. While CAVH technologies relate to centralized systems configured to provide individual vehicles with customized, detailed, and time-sensitive control instructions and traffic information to all vehicles using the CAVH system for automated vehicle driving regardless of vehicle capability and/or automation level and thus provide a homogeneous service, the DDS and IRT technologies described herein are vehicle-oriented, modular, and customizable for each vehicle to meet the specific needs of each individual vehicle as an on-demand and dynamic service.

In some embodiments, the IRT technology described herein is provided as a component of a DDS. In some embodiments, the IRT technology described herein interacts with a DDS. In some embodiments, the DDS comprises: 1) one or more connected and automated vehicles (CAVs) comprising a vehicle onboard system; 2) an intelligent roadside toolbox (IRT); and 3) communications media (e.g., wireless communications (e.g., real-time wireless communications media)) for transmitting data between the CAVs and the IRT. In some embodiments, a vehicle onboard system is configured to generate control instructions for automated driving of a CAV comprising the vehicle onboard system; and the IRT provides customized, on demand, and dynamic IRT functions to individual CAVs (e.g., sensing services, transportation behavior prediction and management services, planning and decision making services, vehicle control services, system security and backup, vehicle performance optimization, computing and management, and dynamic utility management (DUM) and information provision).

In some embodiments, the DDS is configured to provide on demand and dynamic IRT functions to individual CAVs to avoid trajectory conflicts with other vehicles (e.g., collision avoidance) and/or to adjust vehicle route and/or trajectory for abnormal driving environments (e.g., weather events, natural disasters, traffic accidents, etc.) In some embodiments, the DDS comprises a DUM module configured to optimize use of resources by CAVs at various vehicle intelligence levels by performing a method comprising assembling IRT functions to provide to CAVs; and balancing CAV onboard system costs. In some embodiments, the CAV onboard system costs comprise computation ability cost (C), number of computational units cost (NU), fuel consumption cost (P), and climate control and/or driver comfort (e.g., acceleration and/or deceleration) cost (V). In some embodiments, the DUM module is configured to optimize resources by CAVs at various vehicle intelligence levels by optimizing a cost function (e.g., identifying an optimal minimum of the cost function) describing the total cost to implement an automated driving system as a sum of functions (e.g., functions providing positive values) for computation ability cost (C), number of computational units cost (NU), fuel consumption cost (P), climate control and/or driver comfort (e.g., acceleration and/or deceleration) cost (V), and/or IRT cost (I).

In some embodiments, the IRT provides customized, on demand, and dynamic IRT functions to improve safety and stability of individual CAVs according to the needs of individual CAVs by assembling IRT functions and providing IRT functions to individual CAVs. In some embodiments, the DDS is configured to measure the performance of a CAV according to an index describing the computational ability of the CAV, the emission output of the CAV, the energy consumption of the CAV, and/or the comfort of a driver of the CAV. In some embodiments, computational ability comprises computation speed for sensing, prediction, decision making, and/or control; energy consumption comprises fuel economy and/or electricity economy; and the comfort of the driver comprises climate control and/or acceleration/deceleration of the CAV.

In some embodiments, the DDS is configured to provide a customized IRT to supplement an individual CAV according to vehicle manufacturer designs to improve CAV performance. In some embodiments, the DDS is configured to provide supplemental functions to an individual CAV in response to the value of a vehicle cost function exceeding a threshold and/or in response to detecting a component, function, and/or service failure. In some embodiments, the IRT is configured to provide a customized service for vehicle manufacturers and/or driving services providers, the customized service comprising remote-control service, pavement condition detection, and/or pedestrian prediction. In some embodiments, the IRT is configured to receive information from a vehicle OBU, electronic stability program (ESP), and/or vehicle control unit (VCU).

In some embodiments, the DDS is configured to determine CAV information and/or functional requirements based on a cost function describing the total cost to implement an automated driving system as a sum of functions for computation ability cost (C), number of computational units cost (NU), fuel consumption cost (P), climate control and/or driver comfort (e.g., acceleration and/or deceleration) cost (V), and/or IRT cost (I); and send the information and/or functional requirements to the IRT for providing supplemental information and/or functions to a CAV.

In some embodiments, the DDS is configured to integrate sensor and/or driving environment information from different resources to provide integrated sensor and/or driving environment information and pass the integrated sensor and/or driving environment information to a prediction module. In some embodiments, the DDS is configured to provide customized, on demand, and dynamic IRT functions to individual CAVs for sensing, transportation behavior prediction and management, planning and decision making, and/or vehicle control. In some embodiments, sensing comprises providing information in real-time, short-term, and/or long-term for transportation behavior prediction and management, planning and decision making, and/or vehicle control. In some embodiments, the DDS is configured to provide system security and backup, vehicle performance optimization, computing and management, and dynamic utility management for a CAV. In some embodiments, the DDS is configured to provide customized, on demand, and dynamic IRT sensing functions for automated driving of a CAV using information obtained from the CAV and/or other CAVs and/or information obtained from the IRT. In some embodiments, the DDS is configured to provide customized, on demand, and dynamic IRT transportation behavior prediction and management functions for automated driving of a CAV, wherein the transportation behavior prediction and management functions predict the behavior of surrounding vehicles, pedestrians, bicycles, and other moving objects.

In some embodiments, the transportation behavior prediction and management functions provide prediction support comprising providing raw data and/or providing features extracted from raw data; and/or a prediction result, wherein prediction support and/or a prediction result is/are provided to a CAV based on the prediction requirements of the CAV. In some embodiments, the DDS is configured to provide customized, on demand, and dynamic IRT planning and decision making functions for automated driving of a CAV. In some embodiments, the planning and decision making functions provide path planning comprising identifying and/or providing a detailed driving path at a microscopic level for automated driving of a CAV; route planning comprising identifying and/or providing a route for automated driving of a CAV; special condition planning comprising identifying and/or providing a detailed driving path at a microscopic level and/or a route for automated driving of a CAV during special weather conditions or event conditions; and/or disaster solutions comprising identifying and/or providing a detailed driving path at a microscopic level and/or a route for automated driving of a CAV during a disaster, wherein path planning, route planning, special condition planning, and/or disaster solutions is/are provided to a CAV based on the planning and decision making requirements of the CAV.

In some embodiments, the DDS comprises a control module and a decision making module. In some embodiments, the DDS is configured to provide customized, on demand, and dynamic IRT vehicle control functions for automated driving of a CAV. In some embodiments, the vehicle control functions are supported by customized, on demand, and dynamic IRT sensing functions; customized, on demand, and dynamic IRT transportation behavior prediction and management functions; and/or customized, on-demand, and dynamic IRT planning and decision making functions. In some embodiments, vehicle control functions provide lateral control, vertical control, platoon control, fleet management, and system failure safety measures for a CAV. In some embodiments, system failure safety measures are configured to provide sufficient response time for drivers to assume control of a vehicle during system failure and/or to stop vehicles safely. In some embodiments, the vehicle control functions are configured to determine the computation resources supporting automated driving of a CAV and request and/or provide supplemental computation resources from the IRT. In some embodiments, the control module is configured to integrate and/or process information provided by the decision making module and to send vehicle control commands to CAVs for automated driving of the CAVs.

In some embodiments, the DDS is configured to determine an optimal vehicle power consumption and driver comfort for an individual CAV to minimize power consumption and emissions and send the optimal vehicle power consumption and driver comfort to the CAV using the communications media.

In some embodiments, the IRT comprises hardware modules, the hardware modules comprising a sensing module comprising sensors, a communications module, and/or a computation module. In some embodiments, the IRT comprises software modules, the software modules comprising sensing software configured to use information from a sensing module to provide object detection and mapping; and decision making software configured to provide paths, routes, and/or control instructions for CAVs.

In some embodiments, DDS is configured to provide system backup and redundancy services for individual CAVs, wherein the provide system backup and redundancy services provide backup and/or supplemental sensing devices for individual CAVs requiring sensing support; and/or backup and/or supplemental computational resources for individual CAVs to maintain CAV performance levels. In some embodiments, the DDS is configured to provide system backup and redundancy services for individual CAVs using the communications media. In some embodiments, the DDS is configured to collect sensor data describing the environment of a CAV; and provide at least a subset of the sensor data to a CAV to supplement a malfunctioning and/or deficient sensor system of the CAV to maximize proper functioning of the CAV. In some embodiments, the sensor data is provided by an IRT sensing module. In some embodiments, the sensor data and the at least a subset of the sensor data are communicated between the DDS and the CAV over the communications medium. In some embodiments, the sensor data comprises information describing road conditions, traffic signs and/or signals, and objects surrounding the CAV. In some embodiments, the DDS is further configured to integrate the data; provide the data to a prediction, planning, and decision making system; store the data; and/or retrieve the at least a subset of data.

### Automated Driving Services Community

In some embodiments, the technology provides an automated driving services community. The automated driving services community is a platform (e.g., a digital distribution platform) that provides software (e.g., automated driving service applications) and from which users download specific automated driving service applications to their vehicles (e.g., for use by the vehicles). Similarly, developers upload their automated driving service applications to the automated driving services community for users to download (e.g., purchase) for use on vehicles. In some embodiments, the automated driving services community provides a marketplace for applications that provide functionality to vehicles by obtaining support from IRT services. In some embodiments, the automated driving services community is a digital storefront providing users with search capabilities and reviews of automated driving service applications for sale electronically. In some embodiments, the automated driving services community provides a secure and uniform experience for developers and users that automates the electronic purchase and installation of automated driving service applications for vehicles. An automated driving services application provides a specific set of functions for a vehicle that are provided by the IRT. The IRT provides the hardware to support the applications provided by the automated driving services community. In some embodiments, applications published on the automated driving services community provide sensing functions and/or services, transportation behavior prediction and management functions and/or services, planning and decision making functions and/or services, and/or vehicle control functions and/or services.

Although the disclosure herein refers to certain illustrated embodiments, it is to be understood that these embodiments are presented by way of example and not by way of limitation.

### Example

During the development of embodiments of the IRT technology described herein, IRT-related technologies were designed for building and/or testing.

For example, exemplary embodiments of the technology provide a sensing device for the IRT comprising a LIDAR (Light Detection and Ranging) component. The IRT technology comprises a LIDAR component with hardware technical specifications including providing an effective detection distance greater than 50 m and rapid scanning over a field of view of 360° with a detection error rate of 99% confidence within 5 cm. Several LIDAR devices and/or components are presently on the market, including, e.g., R-Fans_16 (Beijing Surestar Technology Co., Ltd; see www.isurestar.com/index.php/en-product-product.html#9), TDC-GPX2 LIDAR (precision measurement technologies; pmt-fl.com), and HDL-64E (Velodyne Lidar; velodynelidar. com/index. html). Further, the IRT technology comprises a LIDAR component with software technical specifications including providing measurements of the headway between two vehicles, measurements between carriageway markings and vehicles, and measurements of the angle between vehicles and central lines. The ArcGIS software (desktop. arcgis. com/en/arcmap) provides tools for processing and visualizing LIDAR data. Present commercially products provide the hardware and software technical specifications of the IRT LIDAR component.

Exemplary embodiments of the technology provide a sensing device for the IRT comprising a camera. The camera provides basic functions including, e.g., detecting vehicles, detecting pedestrians, detecting and recognizing traffic signs, and/or detecting and recognizing lane markings. The IRT technology comprises a camera component with hardware technical specifications including providing a 170-degree high resolution ultra-wide angle and/or night vision capabilities. The IRT technology comprises a camera component with software technical specifications including providing an error rate for vehicle detection that is 99% confidence above 90% and an error rate for lane detection accuracy that is 99% confidence above 90%. Further the IRT technology comprises a camera component with software technical specifications including providing extracting of drivable paths and measuring the acceleration of vehicles. Several camera devices and/or components are presently on the market, including the EyEQ4 (Mobileye; www. mobileye. com/our-technology). The Mobileye system provides barrier and guardrail detection (see, e.g., U.S. Pat. App. Pub. No. 20120105639, incorporated herein by reference); image processing (see, e.g., EP2395472A1, incorporated herein by reference); path prediction (see, e.g., U.S. Pat. App. Pub. No. 20160325753, incorporated herein by reference); and road vertical contour detection (see, e.g., U.S. Pat. App. Pub. No. 20130141580, incorporated herein by reference). A camera mount is described in U.S. Pat. App. Pub. No. 20170075195, incorporated herein by reference. The Mobileye technology provides a sensing technology that uses algorithms for supervised learning. Further, the Mobileye technology comprises driving policy algorithms that use reinforcement learning (e.g., a system of rewards and punishments) to train an artificial intelligence/machine learning component learn to negotiate a road and other drivers.

While cameras are presently installed on individual vehicles, image processing technology for the IRT technology described herein is modified for cameras installed on roadside infrastructure (e.g., on an RSU). During the development of the technology provided herein, experiments are conducted to improve image recognition and processing of cameras to provide determining the drivable area and the delimiters of the drivable area, recognizing the geometry of routes within the drivable area, and recognizing all road users within the drivable area or path.

Exemplary embodiments of the technology provide a sensing device for the IRT comprising a microwave radar component. The IRT technology comprises a microwave radar component with hardware technical specifications including providing reliable detection accuracy with isolation belt; automatic lane segmentation on a multi-lane road; detection errors for vehicle speed, traffic flow, and occupancy that are less than 5%; and an ability to work under temperature lower than −10° C. Furthermore, the IRT technology comprises a microwave radar component with software technical specifications including providing measurement of the speed of passing vehicles, measurement of the volume of passing vehicles, and measurement of the acceleration of passing vehicles. Several microwave radar devices and/or microwave radar components are presently on the market, including the STJ1-3 (Sensortech; www.whsensortech.com). The STJ1-3 comprises software that provides an algorithm to convert raw radar data to traffic information. Present commercially products provide the hardware and software technical specifications of the IRT microwave radar component.

Exemplary embodiments of the technology comprise a software component that accepts data, processes data, and/or outputs processed data. For example, exemplary IRT components comprise a software component that provides data fusion. Data fusion technologies are known and commercially available including data processing and data intelligence technologies (e.g., from Data Fusion Technologies) that provide accurate and efficient combination of data and information from multiple sources and backup services to address problems with sensor function and/or sensor data.

Exemplary embodiments of the technology provide a communication component for the IRT. The communication component provides communication with vehicles and has hardware technical specifications including conformance with communications standards (e.g., IEEE 802.11p (DSRC)) and other IEEE 802.11 wireless communications standards), a bandwidth of 10 MHz, a data rate of 10 Mbps, use of cyclic delay diversity (CDD) for antenna transmit diversity, an environmental operating range of −40° C. to 55° C., a frequency band of 5 GHz, a Doppler spread of 800 km/hour, a delay spread of 1500 ns, and a power supply of 12 V or 24 V. Several communications components are presently on the market including, e.g., MK5 V2X (Cohda Wireless; cohdawireless. com) and StreetWAVE (Savari; savari. net/technology/road-side-unit). During the development of the technology provided herein, experiments are conducted to improve the stability of communications provided by the communications component in complex driving environments. Furthermore, in some embodiments, the IRT communications component provides communication with infrastructure (e.g., components of a CAVH system, IRIS, or other infrastructure). In some embodiments, the IRT communications component provides communications with point TCUs. Accordingly, the IRT communications component has hardware technical specifications that conform with communications standards such as, e.g., ANSI/TIA/EIA-492AAAA and 492AAAB. In some embodiments, the IRT communications component provides communications over wired media such as, e.g., optical fiber or other high-speed wired infrastructure. The IRT communications component has an environmental operating range of −40° C. to 55° C. Several communications components are presently on the market including optical fiber from Cablesys (https://www.cablesys.com/fiber-patch-cables/).

Exemplary embodiments of the technology provide a computation component for the IRT. The computation component of the IRT is configured to fuse data collected from multiple sensors. Accordingly, the computation component provides accurate positioning and orientation estimation of vehicles, high resolution-level traffic state estimation, autonomous path planning, and/or real-time incident detection. Similar computation components are presently used in vehicles, e.g., the External Object Calculating Module (EOCM) provided in the active safety systems of some vehicles (e.g., Buick LaCrosse). The EOCM system integrates data from different sources including a megapixel front camera, long-distance radar, and sensors to provide efficient and precise decision making processes (see, e.g., U.S. Pat. No. 8,527,139, incorporated herein by reference).

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in the art are intended to be within the scope of the following claims.

That which is claimed:

1-78. (canceled)

79. A Distributed Driving System with an Intelligent Roadside Toolbox (DDS-IRT), comprising:
an Intelligent Roadside Toolbox (IRT) comprising a cloud;
a Connected Automated Vehicle (CAV); and
a communication module configured to communicate with said CAV and said IRT, wherein:
said IRT comprises an IRT computation component that collects data from multiple sensors, fuses the data from multiple sensors to produce IRT fused data, and provides the IRT fused data to said CAV;
said CAV comprises a CAV computation component that collects data from multiple sensors and fuses the data from multiple sensors to produce CAV fused data;
and
said IRT provides automated driving services to said CAV operating at a first automated driving level, wherein the automated driving services improve the automated driving of said CAV to allow said CAV to operate at a second automated driving level, wherein the second automated driving level is higher than the first automated driving level,
thereby providing a customized, on-demand, and dynamic virtual automated driving service that replaces one or more automated driving tasks for the CAV.

80. The DDS-IRT system of claim 79, wherein said IRT fused data is:
collected from multiple sensors from one or more CAVs; and/or provided by one or more components of a connected automated vehicle highway (CAVH) and/or an intelligent road infrastructure system (IRIS).

81. The DDS-IRT system of claim 79, wherein said CAV fused data is:
collected from multiple sensors from one or more CAVs; and/or
provided by one or more components of a CAVH and/or an IRIS.

82. The DDS-IRT system of claim 79, configured to enhance, complete, and/or replace the automated driving tasks for said CAV.

83. The DDS-IRT system of claim 79, configured to provide sensing functions, transportation behavior prediction and management functions, planning and decision-making functions, and/or vehicle control functions to said CAV.

84. The DDS-IRT system of claim 79, configured to produce sensing data, integrate sensing data, and/or manage sensing data sharing between said IRT and said CAV to improve functions of said CAV based on a target system intelligence level.

85. The DDS-IRT system of claim 79, configured as an open platform comprising a roadside unit (RSU) network; three-way interface among the IRT, CAV, and supporting systems; traffic control unit (TCU) and traffic control center (TCC) network; and/or traffic operations centers (TOC).

86. A Distributed Driving System with an Intelligent Roadside Toolbox (DDS-IRT), comprising:
an Intelligent Roadside Toolbox (IRT) comprising a cloud;
a Connected Automated Vehicle (CAV); and
a communication module configured to communicate with said CAV and said IRT,
wherein:
said IRT comprises an IRT computation component that collects data from multiple sensors, fuses the data from multiple sensors to produce IRT fused data, and provides the IRT fused data to said CAV;
said CAV comprises a CAV computation component that collects data from multiple sensors and fuses the data from multiple sensors to produce CAV fused data;
said IRT provides customized, on-demand, and dynamic IRT transportation behavior prediction and management functions for automated driving of said CAV, wherein the transportation behavior prediction and management functions predict behavior of surrounding vehicles, pedestrians, bicycles, and other moving objects; and
said IRT provides automated driving services to said CAV operating at a first automated driving level, wherein the automated driving services improve the automated driving of said CAV to allow said CAV to operate at a second automated driving level, wherein the second automated driving level is higher than the first automated driving level,
thereby providing a customized, on-demand, and dynamic virtual automated driving service that replaces one or more automated driving tasks for the CAV.

87. The DDS-IRT system of claim 86, configured to supplement or replace transportation behavior prediction and management services provided by said CAV with virtual transportation behavior prediction and management services provided by the IRT.

88. The DDS-IRT system of claim 86, configured to supplement or replace planning and decision-making services provided by said CAV with planning and decision-making services provided by the IRT.

89. The DDS-IRT system of claim 86, configured to predict vehicle movements and traffic for a transportation network at a microscopic level, at a mesoscopic level, and/or at a macroscopic level.

90. The DDS-IRT system of claim 86, configured to predict vehicle movements and/or traffic due to special events, traffic incident, weather, weaving section, platoon splitting, platoon formation, platoon integrating, variable speed limit reaction, segment travel time prediction, and/or road segment traffic flow.

91. The DDS-IRT system of claim 86, configured to predict special events, traffic incident, weather, weaving section, platoon splitting, platoon formation, platoon integrating, variable speed limit reaction, segment travel time, and/or road segment traffic flow.

92. The DDS-IRT system of claim 86, configured to generate and/or send route planning and decision making information and/or commands to an onboard unit (OBU) and/or a vehicle control unit (VCU) of said CAV.

93. A Distributed Driving System with an Intelligent Roadside Toolbox (DDS-IRT), comprising:
an Intelligent Roadside Toolbox (IRT) comprising a cloud;
a Connected Automated Vehicle (CAV); and
a communication module configured to communicate with said CAV and said IRT,
wherein:
said IRT comprises an IRT computation component that collects data from multiple sensors, fuses the data from multiple sensors to produce IRT fused data, and provides the IRT fused data to said CAV;
said IRT computation component provides real-time incident detection;
said IRT provides emergency service to the CAV;
said CAV comprises a CAV computation component that collects data from multiple sensors and fuses the data from multiple sensors to produce CAV fused data; and
said IRT provides automated driving services to said CAV operating at a first automated driving level, wherein the automated driving services improve the automated driving of said CAV to allow said CAV to operate at a second automated driving level, wherein the second automated driving level is higher than the first automated driving level,
thereby providing a customized, on-demand, and dynamic virtual automated driving service that replaces one or more automated driving tasks for the CAV.

94. The DDS-IRT system of claim 93, wherein said emergency service is provided by an emergency vehicle.

95. The DDS-IRT system of claim 93, configured to optimize a plurality of optimization goals comprising safety, minimizing and/or eliminating conflicts with other vehicles, avoiding dangerous weather, and/or avoiding obstacles in a road.

96. The DDS-IRT system of claim 93, configured to predict vehicle movements and/or traffic due to special events, traffic incident, weather, weaving section, platoon splitting, platoon formation, platoon integrating, variable speed limit reaction, segment travel time prediction, and/or road segment traffic flow.

97. The DDS-IRT system of claim 93, configured to provide customized, on-demand, and dynamic IRT vehicle control functions for said CAV, wherein said IRT vehicle control functions provide system failure safety measures for said CAV.

98. The DDS-IRT system of claim 93, configured to provide supplemental functions to said CAV in response to detecting a component, function, and/or service failure.
